(19) United States
(12) Patent Application Publication
(10) Pub. No.: US 2025/0024478 A1
(43) Pub. Date: Jan. 16, 2025

(54) INDICATION OF PREFERRED SCHEDULING MODE FOR ENERGY HARVESTING

(71) Applicant: QUALCOMM Incorporated, San Diego, CA (US)

(72) Inventors: Ruiming ZHENG, Beijing (CN); Chao WEI, Beijing (CN); Kangqi LIU, San Diego, CA (US); Hao XU, Beijing (CN)

(21) Appl. No.: 18/713,414

(22) PCT Filed: Jan. 24, 2022
(86) PCT No.: PCT/CN2022/073390

§ 371 Date: May 24, 2024

(51) Int. Cl. H04W 72/51; H02J 50/00; H04W 72/115

(52) U.S. Cl. CPC H04W 72/51; H02J 50/001; H04W 72/115

(57) ABSTRACT

Some techniques described herein provide indication of a preferred scheduling mode for a user equipment (UE) based at least in part on an energy harvesting state of the UE. For example, the preferred scheduling mode may indicate a configured grant scheduling mode or a dynamic grant scheduling mode and/or one or more parameters associated with the preferred scheduling mode. For example, the one or more parameters may be based at least in part on an energy harvesting state of the UE. By indicating the preferred scheduling mode, the UE can selectively perform a transmission using a dynamic grant resource or a configured grant resource. Thus, the UE can request a dynamic grant resource when the UE is associated with a high energy level or a relatively fast charging rate, or a CG resource when the UE is associated with a low energy level ora relatively slow charging rate.

### FIELD OF THE DISCLOSURE

Aspects of the present disclosure generally relate to wireless communication and to techniques and apparatuses for indication of a preferred scheduling mode for energy harvesting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

A user equipment (UE) (e.g., a reduced capability UE, a passive Internet of Things (IoT) UE, or the like) may perform energy harvesting to charge the UE's battery. For example, the UE may opportunistically harvest energy from the UE's environment, such as by collecting solar power, heat energy, ambient radio frequency radiation, or the like. The UE may store the harvested energy in a rechargeable battery. Some energy harvesting devices may use a low power wakeup signal (LP-WUS) (which is a signal indicating that the UE should wake up from a deep sleep for communication) or low power wake up receiver (LP-WUR) (which is a receiver designed to receive LP-WUSs or other communications while in a low-power state) for downlink communication, which further reduces power consumption and enables operation on intermittently harvested energy.

As mentioned above, energy harvesting involves the harvesting of ambient energy from the UE's environment. Ambient energy sources may be intermittently available. A UE may experience intermittent energy outages if the UE's energy consumption exceeds stored energy and/or a rate of energy harvesting of the UE, and thus may not always have sufficient energy to facilitate transmissions of the UE. In some wireless communication systems, such as those utilizing a 5G/NR radio access technology (RAT), a UE may transmit a buffer status report (BSR) to request an uplink resource for a transmission (which may be provided to the UE via a dynamic grant). However, the intermittent nature of the energy harvesting UE's available energy may mean that granted uplink resources cannot be reliably utilized in some conditions. Furthermore, the network may dynamically or continuously grant uplink resources to the UE without regard for the UE's energy harvesting state (described in more detail elsewhere herein), which may cause an energy outage of the UE. Such energy outages may delay or interrupt communications of the UE and reduce reliability of the UE. A configured grant (CG) may provide time for an energy harvesting UE to harvest energy between granted resources. However, a BSR may not indicate whether a UE requests a CG or a dynamic grant. Furthermore, a CG is associated with a configuration which indicates various parameters associated with the CG, including a periodicity, a time/frequency resource allocation, and so on. Different energy harvesting UEs may have different traffic patterns, energy harvesting states, and so on. Therefore, a network node may fail to configure an appropriate CG or dynamic grant resource for an energy harvesting UE if the network node is unaware of parameters that would be appropriate for the energy harvesting UE, which may lead to wasted CG resources or over-usage of an energy harvesting UE's energy.

Some techniques and apparatuses described herein provide indication of a preferred scheduling mode for a UE based at least in part on an energy harvesting state of the UE. For example, the preferred scheduling mode may indicate a CG scheduling mode or a dynamic grant scheduling mode. In some aspects, the indication may indicate one or more parameters associated with the preferred scheduling mode, whether a hybrid automatic repeat request (HARQ) feedback resource should be configured, or the like. For example, the one or more parameters may be based at least in part on an energy harvesting state of the UE.

By indicating the preferred scheduling mode, the UE can selectively perform a transmission using a dynamic grant resource or a CG resource. Thus, the UE can request a dynamic grant resource when the UE is associated with a high energy level or a relatively fast charging rate, or a CG resource when the UE is associated with a low energy level or a relatively slow charging rate. In this way, energy utilization of the UE is improved, which reduces delay and interruption of communications of the UE and which improves reliability of the UE. Furthermore, by indicating parameters associated with the preferred scheduling mode, CG resource utilization may be improved and energy utilization of the UE may be improved.

Some aspects described herein relate to a method of wireless communication performed by a UE. The method may include transmitting, based at least in part on an energy harvesting state of the UE, an indication of a preferred scheduling mode selected from a dynamic grant scheduling mode and a configured grant scheduling mode. The method may include receiving a dynamic grant or an activation of a configured grant in accordance with the preferred scheduling mode. The method may include performing a transmission in accordance with the dynamic grant or the configured grant.

Some aspects described herein relate to a method of wireless communication performed by a network node. The method may include receiving, based at least in part on an energy harvesting state of a UE, an indication of a preferred scheduling mode selected from a dynamic grant scheduling mode and a configured grant scheduling mode. The method may include transmitting a dynamic grant or an activation of a configured grant in accordance with the preferred scheduling mode.

Some aspects described herein relate to a non-transitory computer-readable medium that stores a set of instructions for wireless communication by a UE. The set of instructions, when executed by one or more processors of the UE, may cause the UE to transmit, based at least in part on an energy harvesting state of the UE, an indication of a preferred scheduling mode selected from a dynamic grant scheduling mode and a configured grant scheduling mode. The set of instructions, when executed by one or more processors of the UE, may cause the UE to receive a dynamic grant or an activation of a configured grant in accordance with the preferred scheduling mode. The set of instructions, when executed by one or more processors of the UE, may cause the UE to perform a transmission in accordance with the dynamic grant or the configured grant.

Some aspects described herein relate to a non-transitory computer-readable medium that stores a set of instructions for wireless communication by a network node. The set of instructions, when executed by one or more processors of the network node, may cause the network node to receive, based at least in part on an energy harvesting state of a UE, an indication of a preferred scheduling mode selected from a dynamic grant scheduling mode and a configured grant scheduling mode. The set of instructions, when executed by one or more processors of the network node, may cause the network node to transmit a dynamic grant or an activation of a configured grant in accordance with the preferred scheduling mode.

Some aspects described herein relate to a UE for wireless communication. The user equipment may include a memory and one or more processors coupled to the memory. The one or more processors may be configured to transmit, based at least in part on an energy harvesting state of the UE, an indication of a preferred scheduling mode selected from a dynamic grant scheduling mode and a configured grant scheduling mode. The one or more processors may be configured to receive a dynamic grant or an activation of a configured grant in accordance with the preferred scheduling mode. The one or more processors may be configured to perform a transmission in accordance with the dynamic grant or the configured grant.

Some aspects described herein relate to a network node for wireless communication. The network node may include a memory and one or more processors coupled to the memory. The one or more processors may be configured to receive, based at least in part on an energy harvesting state of a UE, an indication of a preferred scheduling mode selected from a dynamic grant scheduling mode and a configured grant scheduling mode. The one or more processors may be configured to transmit a dynamic grant or an activation of a configured grant in accordance with the preferred scheduling mode.

Some aspects described herein relate to an apparatus for wireless communication. The apparatus may include means for transmitting, based at least in part on an energy harvesting state of the apparatus, an indication of a preferred scheduling mode selected from a dynamic grant scheduling mode and a configured grant scheduling mode. The apparatus may include means for receiving a dynamic grant or an activation of a configured grant in accordance with the preferred scheduling mode. The apparatus may include means for performing a transmission in accordance with the dynamic grant or the configured grant.

Some aspects described herein relate to an apparatus for wireless communication. The apparatus may include means for receiving, based at least in part on an energy harvesting state of a UE, an indication of a preferred scheduling mode selected from a dynamic grant scheduling mode and a configured grant scheduling mode. The apparatus may include means for transmitting a dynamic grant or an activation of a configured grant in accordance with the preferred scheduling mode.

Aspects generally include a method, apparatus, system, computer program product, non-transitory computer-readable medium, user equipment, base station, wireless communication device, and/or processing system as substantially described with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless network.

FIG. 2 is a diagram illustrating an example of a base station in communication with a user equipment (UE) in a wireless network.

FIG. 3 is a diagram illustrating an example of uplink configured grant (CG) communication.

FIG. 4 is a diagram illustrating an example of an open radio access network (O-RAN) architecture.

FIG. 5 is a diagram illustrating an example of indication of a preferred scheduling mode.

FIG. 6 is a diagram illustrating an example of modifying a CG configuration based at least in part on a second indication.

FIG. 7 is a diagram illustrating an example of switching from a configured grant scheduling mode to a dynamic grant scheduling mode.

FIGS. 8 and 9 are flowcharts of example methods of wireless communication.

FIGS. 10 and 11 are diagrams of example apparatuses for wireless communication.

FIGS. 12 and 13 are diagram illustrating examples of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

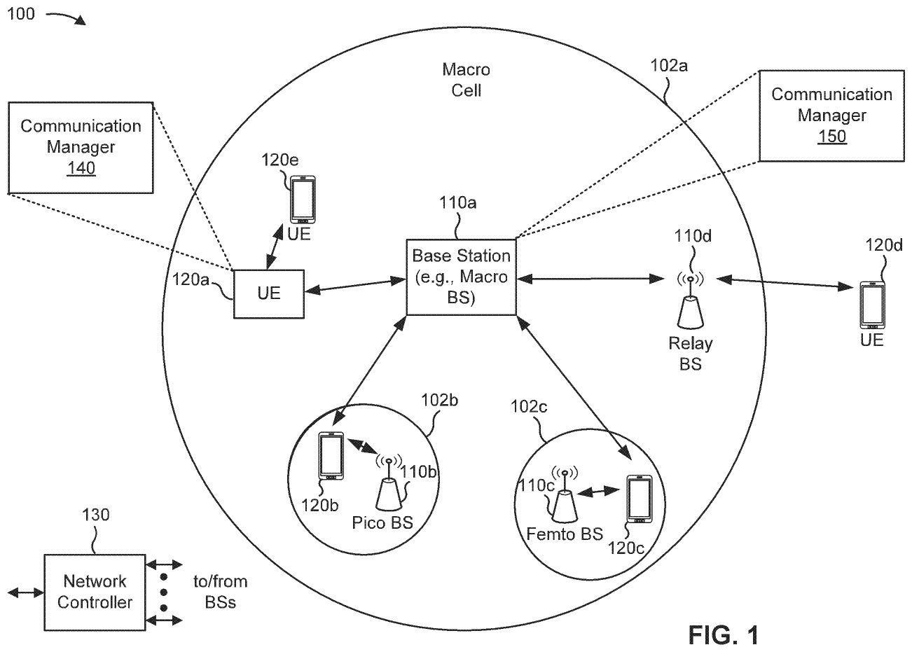

FIG. 1 is a diagram illustrating a wireless network 100 in which aspects of the present disclosure may be practiced. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In some examples, a UE 120 may be capable of energy harvesting. Energy harvesting (e.g., performing energy harvesting) may include collecting energy from an environment of the UE 120. The UE 120 may use the collected energy for communications or other operations. The harvested energy can be solar energy, heat energy, radio frequency (RF) radiation energy, wind energy, and/or another form of energy. In some aspects, the UE 120 may include or be associated with one or more components that perform energy harvesting, such as a solar panel, a thermoelectric component, an RF energy collection component, a wind turbine, or a combination thereof. The UE 120 may also include an energy management component that tracks available energy of the UE 120 (e.g., an energy harvesting state) and manages the usage of the available energy.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G operation beyond 52.6 GHz. For example, three higher operating bands have been identified as frequency range designations FR4a or FR4-1 (52.6 GHz-71 GHZ), FR4 (52.6 GHZ-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, based at least in part on an energy harvesting state of the UE, an indication of a preferred scheduling mode selected from a dynamic grant scheduling mode and a configured grant scheduling mode; receive a dynamic grant or an activation of a configured grant in accordance with the preferred scheduling mode; and perform a transmission in accordance with the dynamic grant or the configured grant. Additionally, or alternatively, the communication manager 140 may perform one or more other operations described herein.

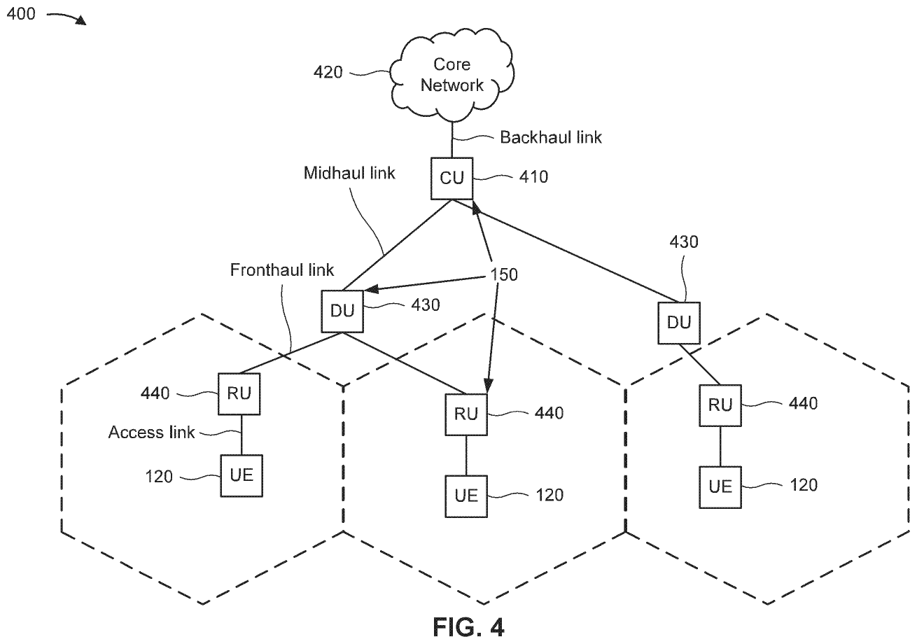

In some aspects, a network node (e.g., base station 110 or one or more functions described in connection with FIG. 4) may include a communication manager 150. As described in more detail elsewhere herein, the communication manager 150 may receive, based at least in part on an energy harvesting state of a UE, an indication of a preferred scheduling mode selected from a dynamic grant scheduling mode and a configured grant scheduling mode; and transmit a dynamic grant or an activation of a configured grant in accordance with the preferred scheduling mode. Additionally, or alternatively, the communication manager 150 may perform one or more other operations described herein.

As indicated above, FIG. 1 is provided as an example. Other examples may differ from what is described with regard to FIG. 1.

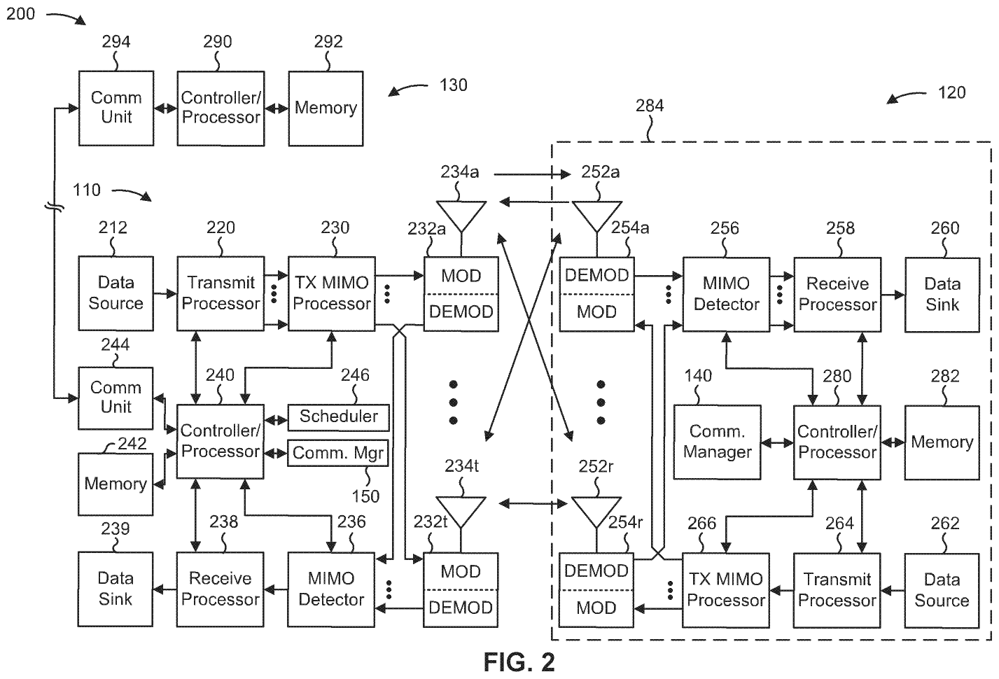

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

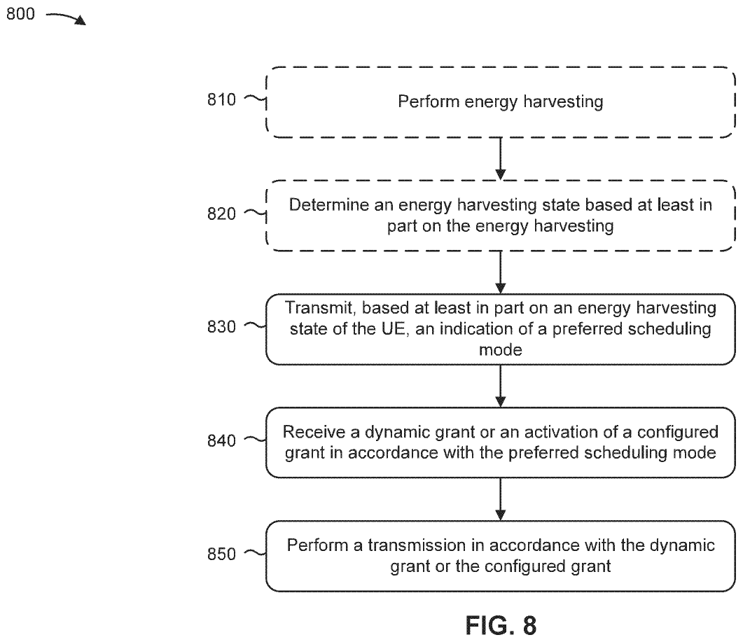

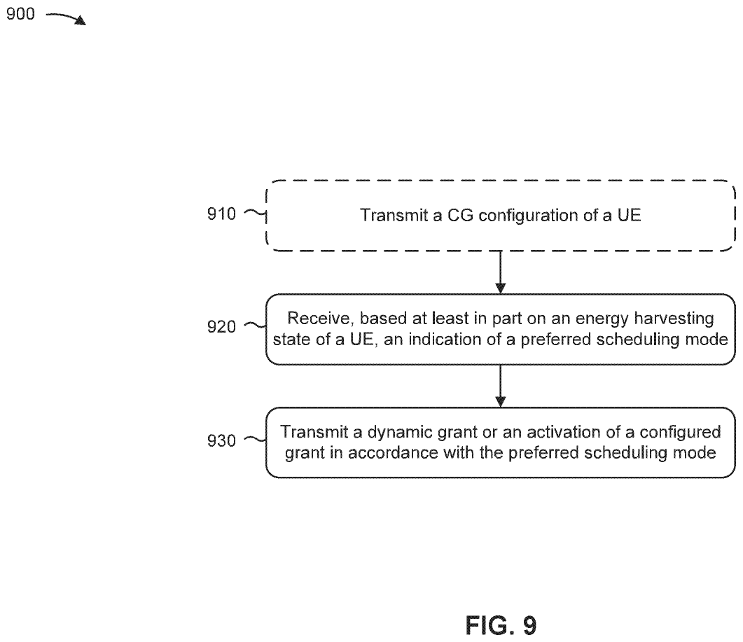

The controller/processor 240 of the base station 110, the controller/processor 280 of the UE 120, and/or any other component(s) of FIG. 2 may perform one or more techniques associated with indication of a preferred scheduling mode, as described in more detail elsewhere herein. For example, the controller/processor 240 of the base station 110, the controller/processor 280 of the UE 120, and/or any other component(s) of FIG. 2 may perform or direct operations of, for example, the method 800 of FIG. 8, the method 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, the method 800 of FIG. 8, the method 900 of FIG. 9, and/or other processes as described herein. In some examples, executing instructions may include running the instructions, converting the instructions, compiling the instructions, and/or interpreting the instructions, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

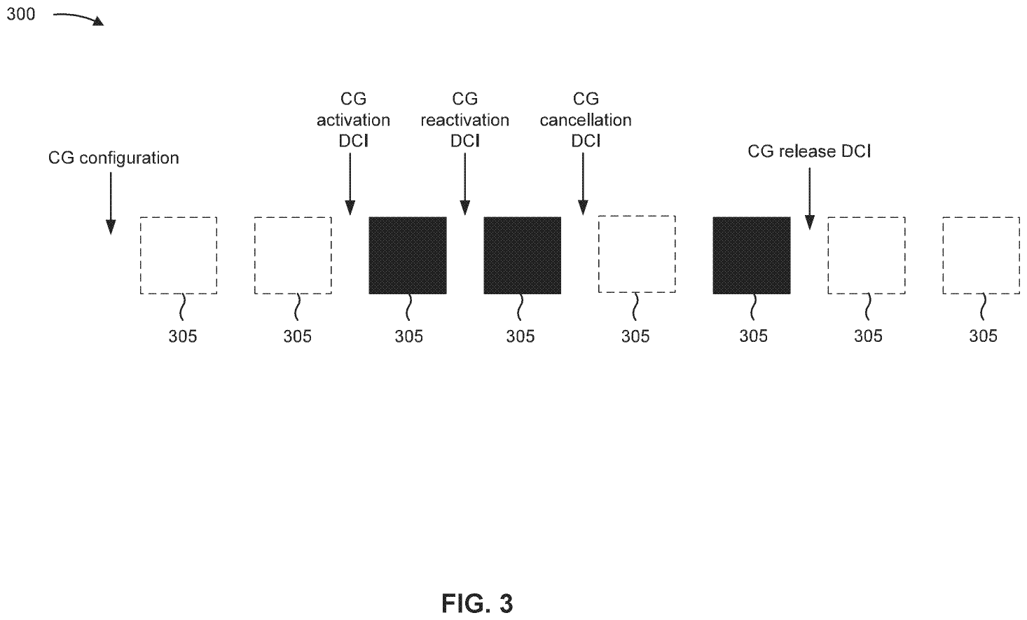

FIG. 3 is a diagram illustrating an example 300 of uplink configured grant (CG) communication. CG communications may include periodic uplink communications that are configured for a UE, such that the base station does not need to send separate downlink control information (DCI) to schedule each uplink communication, thereby conserving signaling overhead.

As shown in example 300, a UE may be configured with a CG configuration for CG communications. For example, the UE may receive the CG configuration via a radio resource control (RRC) message transmitted by a base station. The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 305 for the UE. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The base station may transmit CG activation DCI to the UE to activate the CG configuration for the UE. The base station may indicate, in the CG activation DCI, communication parameters, such as an MCS, an RB allocation, and/or antenna ports, for the CG physical uplink shared channel (PUSCH) communications to be transmitted in the scheduled CG occasions 305. The UE may begin transmitting in the CG occasions 305 based at least in part on receiving the CG activation DCI. For example, beginning with a next scheduled CG occasion 305 subsequent to receiving the CG activation DCI, the UE may transmit a PUSCH communication in the scheduled CG occasions 305 using the communication parameters indicated in the CG activation DCI. The UE may refrain from transmitting in configured CG occasions 305 prior to receiving the CG activation DCI.

The base station may transmit CG reactivation DCI to the UE to change the communication parameters for the CG PUSCH communications. Based at least in part on receiving the CG reactivation DCI, and the UE may begin transmitting in the scheduled CG occasions 305 using the communication parameters indicated in the CG reactivation DCI. For example, beginning with a next scheduled CG occasion 305 subsequent to receiving the CG reactivation DCI, the UE may transmit PUSCH communications in the scheduled CG occasions 305 based at least in part on the communication parameters indicated in the CG reactivation DCI.

In some cases, such as when the base station needs to override a scheduled CG communication for a higher priority communication, the base station may transmit CG cancellation DCI to the UE to temporarily cancel or deactivate one or more subsequent CG occasions 305 for the UE. The CG cancellation DCI may deactivate only a subsequent one CG occasion 305 or a subsequent N CG occasions 305 (where N is an integer). CG occasions 305 after the one or more (e.g., N) CG occasions 305 subsequent to the CG cancellation DCI may remain activated. Based at least in part on receiving the CG cancellation DCI, the UE may refrain from transmitting in the one or more (e.g., N) CG occasions 305 subsequent to receiving the CG cancellation DCI. As shown in example 300, the CG cancellation DCI cancels one subsequent CG occasion 305 for the UE. After the CG occasion 305 (or N CG occasions) subsequent to receiving the CG cancellation DCI, the UE may automatically resume transmission in the scheduled CG occasions 305.

The base station may transmit CG release DCI to the UE to deactivate the CG configuration for the UE. The UE may stop transmitting in the scheduled CG occasions 305 based at least in part on receiving the CG release DCI. For example, the UE may refrain from transmitting in any scheduled CG occasions 305 until another CG activation DCI is received from the base station. Whereas the CG cancellation DCI may deactivate only a subsequent one CG occasion 305 or a subsequent N CG occasions 305, the CG release DCI deactivates all subsequent CG occasions 305 for a given CG configuration for the UE until the given CG configuration is activated again by a new CG activation DCI.

CG communication can be contrasted with dynamic grant (DG) communication. In DG communication, resources for uplink communication are scheduled using dynamic signaling such as DCI. For example, a UE may provide a buffer status report that indicates an amount of data to be transmitted. A base station may transmit a dynamic grant (carried by DCI) indicating a DG resource based at least in part on the buffer status report. The UE may perform an uplink transmission of the data using the DG resource.

CG communication is useful for periodic and/or intermittent traffic. As one example, CG communication may be useful for energy harvesting devices, such as energy harvesting UEs (and particularly passive IoT devices). For example, an energy harvesting device may be able to transmit data only after harvesting enough energy to do so. After transmission, the energy harvesting device may need to harvest energy to facilitate a next communication. The periodic nature of CG occasions may provide an opportunity for a UE to harvest energy in between CG occasions, such that the UE is prepared for transmission upon the occurrence of a CG transmission. The techniques described herein provide signaling of a preferred scheduling mode (of a CG mode or a DG mode) and/or parameters of a CG configuration, such as via a buffer status report. Thus, the base station can configure an appropriate CG configuration for the UE, or the base station can provide a DG resource for a transmission of the UE, in accordance with the signaling of the UE.

As indicated above, FIG. 3 is provided as an example. Other examples may differ from what is described with respect to FIG. 3.

FIG. 4 is a diagram illustrating an example 400 of an open radio access network (O-RAN) architecture. As shown in FIG. 4, the O-RAN architecture may include a central unit (CU) 410 that communicates with a core network 420 via a backhaul link. Furthermore, the CU 410 may communicate with one or more distributed units (DUs) 430 via respective midhaul links. The DUs 430 may each communicate with one or more radio units (Rus) 440 via respective fronthaul links, and the RUs 440 may each communicate with respective UEs 120 via RF access links. The DUs 430 and the RUs 440 may also be referred to as O-RAN DUS (O-DUs) 430 and O-RAN RUs (O-RUs) 440, respectively.

In some aspects, the DUs 430 and the RUs 440 may be implemented according to a functional split architecture in which functionality of a base station 110 (e.g., an eNB or a gNB) is provided by a DU 430 and one or more RUs 440 that communicate over a fronthaul link. Accordingly, as described herein, a base station 110 may include a DU 430 and one or more RUs 440 that may be co-located or geographically distributed. In some aspects, the DU 430 and the associated RU(s) 440 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 430 may correspond to a logical unit that includes one or more base station functions to control the operation of one or more RUs 440. For example, in some aspects, the DU 430 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), RRC, and/or service data adaptation protocol (SDAP), may be hosted by the CU 410. The RU(s) 440 controlled by a DU 430 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 440 handle all over the air (OTA) communication with a UE 120, and real-time and non-real-time aspects of control and user plane communication with the RU(s) 440 are controlled by the corresponding DU 430, which enables the DU(s) 430 and the CU 410 to be implemented in a cloud-based RAN architecture. Other examples of functional splits may be implemented.

In some aspects, one or more of the CU 410, the DU 430, or the RU 440 may perform operations described herein as being performed by a network node. For example, one or more of the CU 410, the DU 430, or the RU 440 may include a communication manager 150, as described above.

As indicated above, FIG. 4 is provided as an example. Other examples may differ from what is described with regard to FIG. 4.

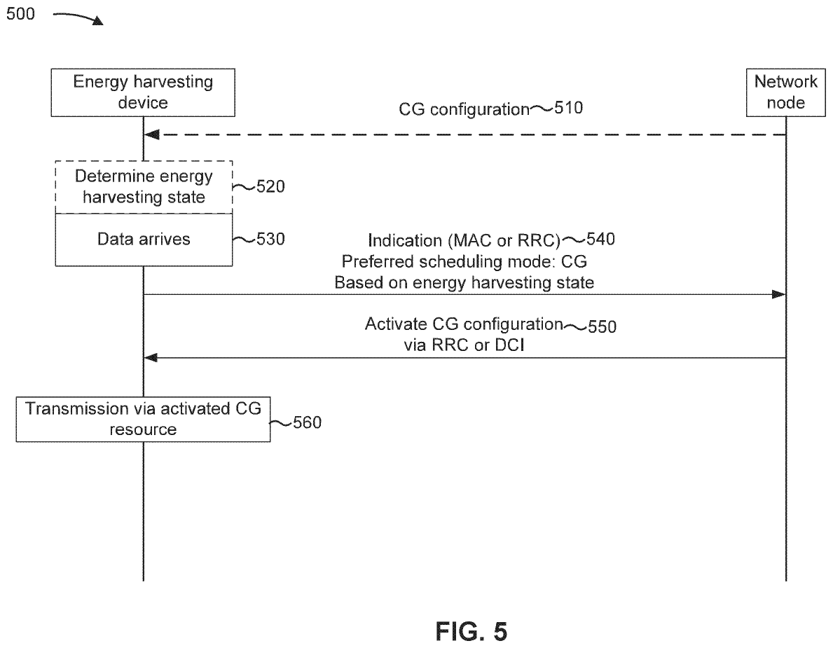

FIG. 5 is a diagram illustrating an example 500 of indication of a preferred scheduling mode. Example 500 includes an energy harvesting device (e.g., UE 120) and a network node (e.g., base station 110, CU 410, DU 430, RU 440, or a combination thereof).

At 510, in some aspects, the network node may provide a CG configuration to the energy harvesting device. The CG configuration may indicate a resource allocation associated with CG uplink communications (e.g., in a time domain, frequency domain, spatial domain, and/or code domain) and a periodicity at which the resource allocation is repeated, as described above. In some aspects, the network node may provide the CG configuration prior to receiving the indication from the energy harvesting device. In some aspects, the network node may configure multiple CG configurations for the energy harvesting device (e.g., which may be associated with respective indexes).

At 520, in some aspects, the energy harvesting device may determine an energy harvesting state of the energy harvesting device. In some aspects, an energy harvesting state may indicate at least one of an energy level of the energy harvesting device or a charging rate of the energy harvesting device. The energy level may indicate an amount of energy that is available for communication by the energy harvesting device, such as based at least in part on a battery level of the energy harvesting device, an energy budget of the energy harvesting device, or the like. The charging rate may indicate a rate of change of the energy level, such as an amount of energy harvested in a time unit. In some aspects, the charging rate can be used to determine a length of time until the energy level satisfies a threshold. In some aspects, the charging rate may indicate whether or not the energy harvesting device is charging, an expected time at which the energy harvesting device will charge, or the like.

At 530, data may arrive for transmission by the energy harvesting device. For example, the energy harvesting device may determine that data is ready for transmission. As another example, the data may be buffered for transmission. For example, the data may be provided by a higher layer (e.g., a packet data convergence protocol layer or a radio link control layer) of the energy harvesting device for buffering and transmission by a lower layer (e.g., a medium access control layer and/or a physical layer) of the energy harvesting device.

At 540, the energy harvesting device may provide an indication. In some aspects, the indication indicates a preferred scheduling mode. The preferred scheduling mode may be selected from a dynamic grant scheduling mode (in which the energy harvesting device communicates using dynamic grant resources scheduled, for example, by DCI) or a configured grant scheduling mode (in which the energy harvesting device communicates using a CG, such as may be configured by the CG configuration). The preferred scheduling mode indicates a scheduling mode that the energy harvesting device has selected as appropriate for scheduling transmissions of the energy harvesting device. In some aspects, the preferred scheduling mode may be indicated by a bit of the indication. In some aspects, the indication may indicate one or more parameters for a CG configuration, or one or more parameters for a dynamic grant, as described in more detail below.

The configured grant scheduling mode may be suitable in situations where the energy harvesting device has a relatively low charging rate or where an energy level of the energy harvesting device is insufficient for dynamic grant transmission. For example, the configured grant scheduling mode may provide time between CG occasions in which the energy harvesting device can perform energy harvesting. Furthermore, the configured grant scheduling mode may reduce the risk of the energy harvesting device having insufficient energy for a transmission upon receiving a dynamic grant. The dynamic grant scheduling mode may be suitable in situations where energy is plentiful for the energy harvesting device (such as when the charging rate of the energy harvesting device is relatively high or where an energy level of the energy harvesting device can facilitate dynamic grant transmission).

In some aspects, the energy harvesting device may select the preferred scheduling mode. For example, the energy harvesting device may select the preferred scheduling mode based at least in part on whether the traffic is periodic or not (e.g., the energy harvesting device may select the configured grant scheduling mode for periodic traffic or the dynamic grant scheduling mode for a one-shot or non-periodic transmission). As another example, the energy harvesting device may select the preferred scheduling mode based at least in part on an energy harvesting state of the energy harvesting device. For example, if an energy level of the energy harvesting device satisfies a threshold, then the energy harvesting device may select a dynamic grant scheduling mode, and if the energy level fails the threshold, the energy harvesting device may select a configured grant scheduling mode. As another example, if a charging rate of the energy harvesting device satisfies a threshold (which may, in some examples, be based at least in part on the energy level or an amount of data to be transmitted), the energy harvesting device may select a dynamic grant scheduling mode, and if the charging rate fails to satisfy the threshold, the energy harvesting device may select a configured grant scheduling mode. In some aspects, the selection of the preferred scheduling mode may be based at least in part on a combination of the energy level and the charging rate. For example, the energy harvesting device may select a configured grant scheduling mode if a current energy level and a current charging rate indicate that insufficient power will be available for dynamic grant communications.

As shown, in some aspects, the indication may be provided via MAC signaling. For example, the energy harvesting device may transmit a MAC control element (MAC-CE). In some examples, the MAC-CE may be a buffer status report (BSR) MAC-CE, though the techniques described herein are not limited to BSR MAC-CEs and can be implemented using other forms of MAC-CE. A BSR MAC-CE is a MAC-CE carrying or indicating a BSR. A BSR is a message or information element indicating a volume of data waiting to be transferred by the energy harvesting device. In some aspects, the energy harvesting device may transmit a MAC-CE requesting a configured grant scheduling mode and/or providing one or more parameters (e.g., requested parameters) for a CG configuration associated with the configured grant scheduling mode. In some aspects, the indication may be provided via RRC signaling. For example, the indication may be provided via UE assistance information. In some aspects, the indication may be provided via a combination of RRC and MAC signaling. For example, the UE may transmit a MAC-CE indicating a volume of data to be transmitted, and the UE may transmit RRC signaling indicating a preferred scheduling mode, a CG configuration, and/or one or more parameters for the CG configuration or a dynamic grant.

In some aspects, the MAC-CE (or the RRC based indication) may be associated with a trigger condition. A trigger condition is a condition for transmitting a MAC-CE or other indication described herein. If the trigger condition is satisfied, the energy harvesting device may prepare and transmit a MAC-CE (or other indication). In some aspects, the trigger condition may be based at least in part on the energy harvesting state of the energy harvesting device. In some aspects, the trigger condition may indicate whether to select a dynamic grant scheduling mode or a configured grant scheduling mode. Additionally, or alternatively, the energy harvesting device may determine whether to select the dynamic grant scheduling mode or the configured grant scheduling mode based at least in part on the trigger condition. In some aspects, the energy harvesting device may select a parameter (e.g., a CG configuration parameter) or a CG configuration based at least in part on a trigger condition. For example, a first trigger condition may be mapped to a first parameter or CG configuration, and a second trigger condition may be mapped to a second parameter or CG configuration. In this example, the energy harvesting device may select a corresponding parameter or CG configuration based at least in part on whether the first trigger condition or the second trigger condition is satisfied.

In some aspects, the trigger condition may be based at least in part on an energy level. For example, if the energy level fails to satisfy a threshold (indicating that insufficient energy is available for dynamic grant transmission), then the trigger condition may be satisfied. Additionally, or alternatively, the trigger condition may be based at least in part on a charging rate. For example, if the charging rate fails to satisfy a threshold, the trigger condition may be satisfied. Thus, if the energy harvesting device determines that, for example, the charging rate is insufficient to exceed power consumption of the energy harvesting device, the energy harvesting device may transmit the indication accordingly. For example, the trigger condition may be based at least in part on a change in the energy harvesting state. In this example, if a charging rate changes by at least a threshold, the trigger condition may be satisfied. As another example, if the energy level of the energy harvesting device falls below a threshold, the trigger condition may be satisfied.

In some aspects, the indication may indicate a CG configuration or one or more parameters associated with the CG configuration. For example, the indication may include one or more indexes associated with one or more CGs (e.g., one or more CG configurations). In some aspects, the energy harvesting device may select the one or more CG configurations based at least in part on a type of traffic (e.g., whether traffic is periodic or non-periodic), a quality of service (QOS) identifier associated with traffic (e.g., a QoS flow identifier or the like), a logical channel group associated with traffic, or the like.

In some aspects, the indication may indicate whether to support physical downlink control channel (PDCCH) monitoring for hybrid automatic repeat request (HARQ) retransmission after a CG data transmission. For example, a HARQ retransmission may be indicated by a HARQ indication, which may be communicated via a PDCCH. The energy harvesting device may monitor for a PDCCH carrying a HARQ indication by performing blind decoding of PDCCH candidates, such as within a monitoring window. In this example, an indicator (e.g., a bit) may indicate whether to enable or disable HARQ retransmission after the CG data transmission. In this example, the energy harvesting device may determine whether to support PDCCH monitoring for HARQ retransmission based at least in part on the energy harvesting state of the energy harvesting device. For example, the energy harvesting device may request the PDCCH monitoring for HARQ retransmission be activated if an energy level of the energy harvesting device satisfies a threshold or if a charging rate of the energy harvesting device satisfies a threshold.

In some aspects, the one or more parameters may indicate a CG periodicity. For example, the one or more parameters may indicate a periodicity associated with CG resources or CG occasions of the CG. In some aspects, the periodicity may indicate a preferred duration for which the energy harvesting device can continuously perform data communication (e.g., the periodicity may be of a length at least equal to the preferred duration). For example, the data communication may include a new data transmission and a potential retransmission scheduled by the network node. In some aspects, the one or more parameters may indicate a number of CG occasions. For example, the one or more parameters may indicate a preferred number of CG occasions for the CG configuration of the energy harvesting device. In some other aspects, the network node may determine the number of CG occasions based at least in part on the buffer status information reported by the energy harvesting device.

In some aspects, the one or more parameters may indicate a grant size. For example, the one or more parameters may indicate a preferred grant size per CG occasion. In some aspects, the grant size may be a grant size at which the energy harvesting device is capable of performing a transmission at each CG occasion. For example, the grant size may be based at least in part on a traffic requirement (e.g., a data rate requirement, a latency requirement, or the like) and the energy harvesting state of the UE. In some aspects, the grant size may be indicated by a parameter, such as an MCS and transport block size (TBS) parameter which may indicate a modulation order, target code rate, and TBS.

In some aspects, the one or more parameters may indicate a logical channel group associated with the indication. For example, traffic may be associated with a logical channel group, which is a group of logical channels for which buffer status can be reported. A logical channel group may be identified by a logical channel group identifier. A BSR may indicate the logical channel group identifier so that the network node can determine buffer state for the logical channel group. In some aspects, the one or more parameters may indicate a radio bearer associated with the indication. For example, traffic may be associated with a radio bearer, which is a channel used by a lower layer of the UE (e.g., Layer 2) to carry traffic between the UE and the network. In some aspects, the one or more parameters may indicate a quality of service (QOS) flow associated with the indication. For example, traffic may be associated with a QoS flow, which is an identifier that associates the traffic with particular QoS parameters.

In some aspects, the energy harvesting device may transmit the indication based at least in part on a timer. The timer may indicate a minimum length of time between transmissions of indications. For example, the energy harvesting device may trigger a timer (sometimes referred to as a prohibit timer) upon transmission of an indication of a preferred scheduling mode. The energy harvesting device may be restricted from transmitting another indication of a preferred scheduling mode until the timer has elapsed. Thus, overhead and signaling resource usage associated with signaling preferred scheduling modes may be reduced.

At 550, the network node may activate a CG configuration. For example, the network node may transmit, and the energy harvesting device may receive, an RRC configuration or DCI configuring and/or activating a CG configuration. Once activated, the CG configuration may provide uplink resources for transmissions of the energy harvesting device until deactivated. The network node may activate the CG configuration based at least in part on the indication. For example, the network node may activate the CG configuration based at least in part on the indication indicating a configured grant scheduling mode as the preferred scheduling mode. If the indication indicates a dynamic grant scheduling mode as the preferred scheduling mode, the network node may provide a dynamic grant for an uplink resource, such as via DCI. The dynamic grant may indicate a resource (sometimes referred to herein as a dynamic grant resource) for a transmission and/or one or more parameters for the transmission. In some aspects, the network node may provide a CG configuration via RRC signaling, such as for a type-1 configured grant (which is provided and reconfigured via RRC signaling). In some other aspects, the network node may activate a CG configuration via DCI indication, such as for a type-2 configured grant (which is activated and deactivated by a DCI indication transmitted via a PDCCH).

The CG configuration may indicate CG resources, as described elsewhere herein. In some aspects, the network node may schedule resources using a dynamic grant, such as based at least in part on whether the indication indicates a CG scheduling mode or a dynamic grant scheduling mode. In some aspects, the network node may select the resources (e.g., CG resources or dynamic grant resources) for the energy harvesting device's transmission. For example, the network node may select the resources based at least in part whether the energy harvesting device communicates using time division duplexing or frequency division duplexing. As another example, the network node may select the resources based at least in part on whether the energy harvesting device communicates in half-duplex or in full-duplex. As yet another example, the network node may select the resources based at least in part on a power class of the energy harvesting device. As still another example, the network node may select the resources based at least in part on a frequency band of the energy harvesting device. As another example, the network node may select the resources based at least in part on a supplementary uplink (SUL) or normal uplink (NUL) carrier of the energy harvesting device. As yet another example, the network node may select the resource based at least in part on whether the energy harvesting device is communicating using an initial bandwidth part or a separate bandwidth part. As still another example, the network node may select the resources based at least in part on a signal strength associated with the energy harvesting device. For example, if a signal strength metric (e.g., a downlink reference signal received power) satisfies a threshold (indicating that the energy harvesting device is close to the network node), then the network node may schedule DG resources, and if the signal strength metric fails to satisfy the threshold (indicating that the energy harvesting device is far from the network node), then the network node may activate CG resources.

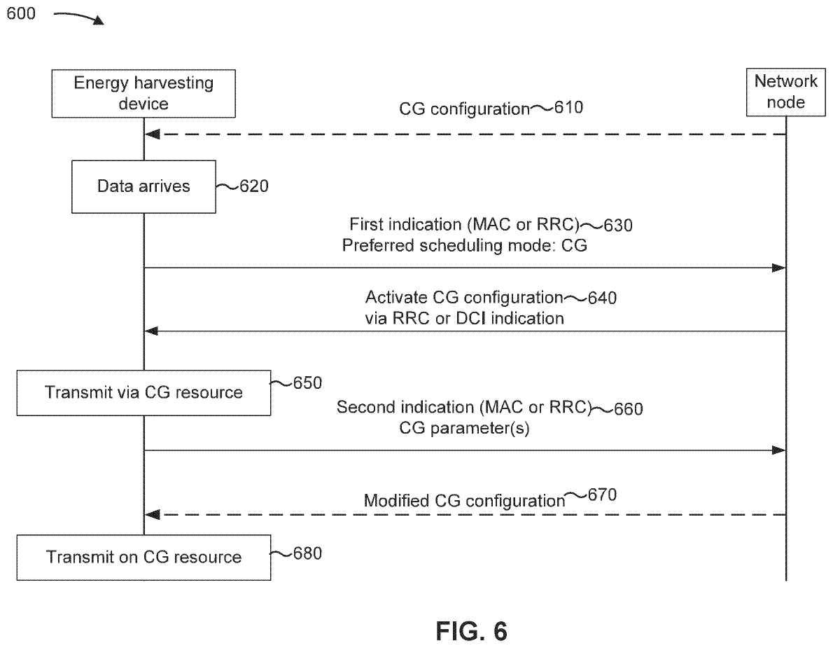

At 560, the energy harvesting device may transmit via CG resources (e.g., CG occasions) associated with the activated CG configuration. For example, the energy harvesting device may perform a transmission (e.g., perform a data transfer, transmit data) via activated CG resources in accordance with the configured grant. If the dynamic grant scheduling mode is used, the energy harvesting device may transmit via dynamic grant resources in accordance with a dynamic grant. In some aspects, the energy harvesting device may monitor particular resources for retransmission or an indication of a retransmission within a configured monitoring window. For example, the energy harvesting device may monitor for a HARQ retransmission indication within a monitoring window defined by a HARQ retransmission timer in between CG occasions. “Monitoring particular resources” may include attempting to receive (e.g., decode) a communication on the particular resources. In some aspects, the energy harvesting device may only monitor the particular resources if the indication indicates to support PDCCH monitoring for HARQ retransmission after a CG data transmission. Additional detail regarding transmission via CG or DG resources is provided in connection with FIGS. 6-8.

As indicated above, FIG. 5 is provided as an example. Other examples may differ from what is described with regard to FIG. 5.

FIG. 6 is a diagram illustrating an example 600 of modifying a CG configuration based at least in part on a second indication. Example 600 includes an energy harvesting device (e.g., UE 120, the energy harvesting device of FIG. 5) and a network node (e.g., base station 110, the network node of FIG. 5, CU 410, DU 430, RU 440, or a combination thereof).

At 610, the energy harvesting device may receive a CG configuration from the network node. The CG configuration is described in more detail in connection with FIG. 5. At 620, data may arrive for transmission by the energy harvesting device. The arrival of data is described in more detail in connection with FIG. 5.

At 630, the energy harvesting device may transmit, and the network node may receive, a first indication. The transmission of the first indication is described in more detail at 540 of FIG. 5. As shown, the first indication indicates a configured grant scheduling mode as a preferred scheduling mode. In some aspects, the energy harvesting device may start a timer (e.g., a prohibit timer) based at least in part on transmitting the first indication. At 640, the network node may activate a CG configuration, such as via RRC or DCI signaling, as described at 550 of FIG. 5. At 650, the energy harvesting device may transmit via a CG resource (e.g., CG occasion) indicated by the activated CG configuration.

At 660, the energy harvesting device may transmit a second indication. The second indication may be transmitted via MAC signaling (such as a BSR MAC-CE) or via RRC signaling (such as via UE assistance information or the like) or a combination thereof. As shown, the second indication indicates one or more parameters (e.g., one or more preferred parameters) for the CG configuration. Thus, the energy harvesting device may transmit the second indication to provide values of the one or more parameters for modification of the CG configuration. In some aspects, the energy harvesting device may transmit the second indication once the timer (which may be started upon transmission of the first indication) has elapsed.

In some aspects, the second indication may indicate a CG configuration. For example, the first indication may be associated with a first CG configuration (associated with a first index), and the second indication may indicate a second CG configuration (associated with a second index) that is different than the first CG configuration. In some aspects, the second indication may indicate one or more parameters, such as a grant size, a number of CG occasions, a periodicity of CG occasions, a logical channel group identifier, an indication of whether to support PDCCH monitoring associated with HARQ retransmission, or the like.

In some aspects, the energy harvesting device may transmit the second indication based at least in part on a trigger condition. For example, the trigger condition may be based at least in part on an energy harvesting state of the energy harvesting device. Thus, the energy harvesting device may transmit the second indication based at least in part on the energy harvesting state of the energy harvesting device. For example, the energy harvesting device may transmit the second indication based at least in part on a change in the energy harvesting state, such as due to an energy level falling below a threshold and/or a charging rate falling below a threshold. In some aspects, the energy harvesting device may transmit the second indication based at least in part on a determination that a charging rate and/or energy level of the energy harvesting device is insufficient for communication using the preferred scheduling mode and/or parameters indicated by the first indication (whether a dynamic grant scheduling mode or a configured grant scheduling mode).

At 670, the network node may modify the CG configuration of the energy harvesting device. For example, the network node may reconfigure one or more parameters of the CG configuration via RRC signaling, thus providing a modified configured grant to the energy harvesting device. As another example, the network node may deactivate the CG configuration associated with the first indication and may reactivate the CG configuration via DCI with one or more parameters indicated by the second indication. As yet another example, the network node may deactivate the CG configuration associated with the first indication and may activate a CG configuration indicated by the second indication. At 680, the energy harvesting device may transmit on a CG resource (e.g., CG occasion) indicated by the modified CG configuration. In this way, the CG configuration used by the energy harvesting device can be modified based at least in part on the energy harvesting state of the energy harvesting device. Thus, changes in traffic and/or charging rates can be accounted for in the CG configuration, which improves efficiency of communication of the energy harvesting device.

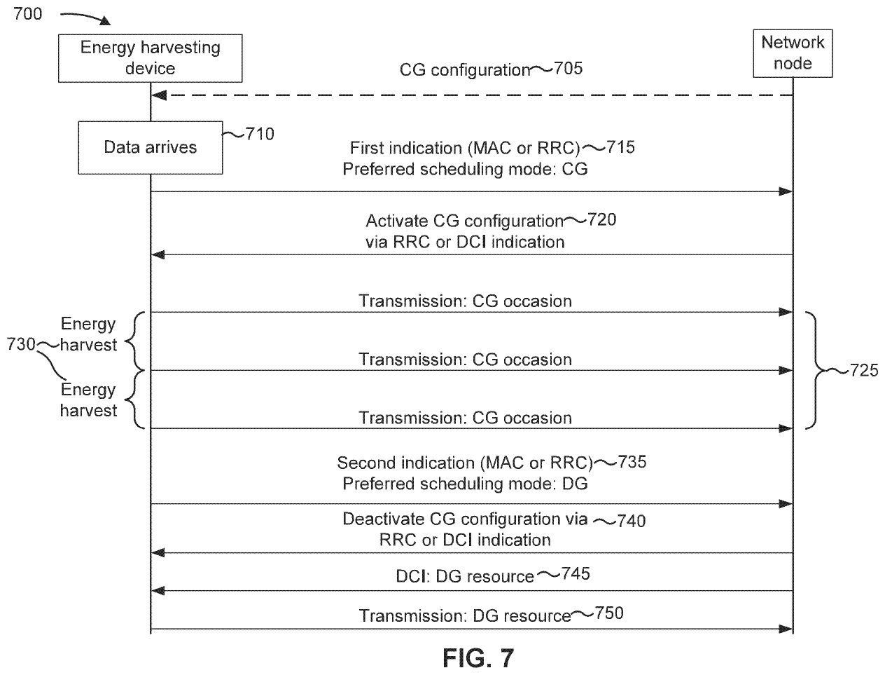

For an example of a second indication that indicates a dynamic grant scheduling mode, refer to FIG. 7.

As indicated above, FIG. 6 is provided as an example. Other examples may differ from what is described with regard to FIG. 6.

FIG. 7 is a diagram illustrating an example 700 of switching from a configured grant scheduling mode to a dynamic grant scheduling mode, in accordance with the present disclosure. Example 700 includes an energy harvesting device (e.g., UE 120, the energy harvesting device of FIGS. 5 and 6) and a network node (e.g., base station 110, the network node of FIGS. 5 and 6, CU 410, DU 430, RU 440, or a combination thereof).

At 705, the energy harvesting device may receive a CG configuration from the network node. The CG configuration is described in more detail in connection with FIG. 5. At 710, data may arrive for transmission by the energy harvesting device. The arrival of data is described in more detail in connection with FIG. 5.

At 715, the energy harvesting device may transmit, and the network node may receive, a first indication. The transmission of the first indication is described in more detail at 540 of FIG. 5. As shown, the first indication indicates a configured grant scheduling mode as a preferred scheduling mode. In some aspects, the energy harvesting device may start a timer (e.g., a prohibit timer) based at least in part on transmitting the first indication. At 720, the network node may activate a CG configuration, such as via RRC or DCI signaling, as described at 550 of FIG. 5.

At 725, the energy harvesting device may transmit communications on CG resources (e.g., CG occasions) of the CG configuration. At 730, the energy harvesting device may perform energy harvesting in between the CG occasions of the CG configuration. For example, the energy harvesting device may use an energy harvesting technique described herein to store energy for a next CG occasion. Thus, the energy harvesting device can utilize a CG to improve reliability and performance of uplink transmissions.

In some aspects, the energy harvesting device may skip one or more transmissions on CG resources. For example, the energy harvesting device may skip a CG occasion (e.g., may not transmit on CG resources of the CG occasion) based at least in part on the energy harvesting device having a low energy state or not having data to transmit. In some aspects, the energy harvesting device many not monitor a PDCCH while skipping the one or more transmissions (e.g., may refrain from monitoring the PDCCH). As used herein, “monitoring a PDCCH” includes performing blind decoding attempts on one or more PDCCH candidates. In some aspects, the energy harvesting device may be permitted to skip a number of CG occasions. For example, the energy harvesting device may be permitted to skip at most M consecutive CG occasions. In some aspects, M may be configured by a network node (e.g., base station 110, CU 410, DU 430). In some aspects, M may be based at least in part on a capability of the energy harvesting device. For example, the energy harvesting device may report a capability indicating a number of consecutive skipped CG occasions supported by the energy harvesting device. The number of consecutive skipped CG occasions may be selected from a value set (in one example, {1, 2, 5, 10, 15, 20}), which may be configured, for example, via system information. The network node may configure M based at least in part on the reported capability of the energy harvesting device. This may be useful, for example, since a lower capability energy harvesting device may benefit from skipping a larger number of consecutive CG occasions than a higher capability energy harvesting device. As another example, the network node may configure M based at least in part on a previous number of skipped CG occasions. For example, the network node may determine M based at least in part on a filtered previous number of skipped CG occasions (e.g., an average number of skipped CG occasions over a time interval). Thus, the energy harvesting device may save and/or harvest energy while skipping the CG occasions. The energy harvesting device may resume transmission once the energy harvesting device has sufficient energy and/or there is data to transmit. In some aspects, the network node may release the CG configuration, such as by transmitting a release (e.g., a DCI indication or RRC signaling (e.g., a deconfiguration)) to the energy harvesting device, if the energy harvesting device skips more than M consecutive CG occasions. Thus, the network node may release the configured resources for other uses, which improves efficiency of network operation.

At 735, the energy harvesting device may transmit, and the network node may receive, a second indication. The second indication is described in more detail at 660 of FIG. 6. As shown, the second indication of example 700 indicates a dynamic grant scheduling mode as a preferred scheduling mode. For example, the energy harvesting device may select the dynamic grant scheduling mode based at least in part on an energy harvesting state of the energy harvesting device and/or an amount of data to be transmitted, as described above. Thus, at 740, the network node may deactivate the CG configuration associated with the first indication. For example, the network node may deactivate the CG configuration via RRC or DCI signaling. At 745, the network node may transmit DCI indicating a DG resource for uplink transmission by the energy harvesting device. In some aspects, the DG resource may be based at least in part on the second indication and/or one or more parameters indicated by the second indication. For example, the DG resource may be based at least in part on a grant size, a code rate, a modulation and coding scheme, or another parameter indicated by the second indication. At 750, the energy harvesting device may perform a transmission using the DG resource. Thus, the energy harvesting device may request dynamic grant scheduling when an energy harvesting state of the energy harvesting device is sufficient to support dynamic grant based communication, which improves efficiency of communication of the energy harvesting device and increases throughput.

It should be noted that the features of examples 500, 600, and 700 can be combined with one another. For example, the energy harvesting device may determine an energy harvesting state in examples 600 and/or 700. As another example, the energy harvesting device may use a timer (e.g., a prohibit timer) in any of examples 600 and/or 700. As yet another example, the energy harvesting device may perform energy harvesting in between CG occasions in examples 500 and/or 600.

As indicated above, FIG. 7 is provided as an example. Other examples may differ from what is described with regard to FIG. 7.

FIG. 8 is a flowchart of an example method 800 of wireless communication. The method 800 may be performed by, for example, an energy harvesting device such as a UE (e.g., UE 120).

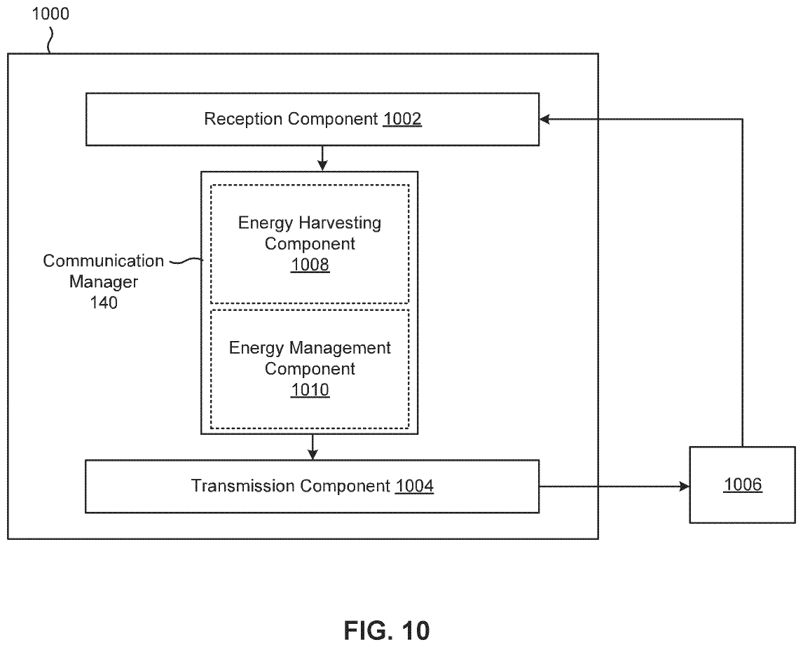

At 810, the UE may optionally perform energy harvesting. For example, the UE (e.g., using communication manager 140 and/or energy harvesting component 1008, depicted in FIG. 10) may harvest energy from the UE's environment. The harvesting of energy is described in more detail elsewhere herein. In some aspects, the energy harvesting is performed between a first configured grant occasion and a second configured grant occasion of a configured grant. In some aspects, method 800 includes monitoring, during the energy harvesting, for network signaling (such as HARQ signaling via a PDCCH) within a monitoring window.

At 820, the UE may optionally determine an energy harvesting state based at least in part on the energy harvesting. For example, the UE (e.g., using communication manager 140 and/or energy management component 1010, depicted in FIG. 10) may determine an energy harvesting state, as described above in connection with, for example FIG. 5 and at 520. The energy harvesting state may be based at least in part on an energy level of the UE, a charging rate of the UE, a combination thereof, and/or one or more other factors.

At 830, the UE may transmit, based at least in part on an energy harvesting state of the UE, an indication of a preferred scheduling mode. For example, the UE (e.g., using communication manager 140 and/or transmission component 1004, depicted in FIG. 10) may transmit, based at least in part on an energy harvesting state of the UE, an indication of a preferred scheduling mode selected from a dynamic grant scheduling mode and a configured grant scheduling mode, as described above in connection with, for example, FIGS. 5-7 at 540, 630, and 715.

In some aspects, the preferred scheduling mode is the dynamic grant scheduling mode based at least in part on the energy harvesting state having an energy level that satisfies a threshold. In some aspects, the preferred scheduling mode is the configured grant scheduling mode based at least in part on the energy harvesting state having an energy level that fails to satisfy a threshold.

In some aspects, the preferred scheduling mode is the dynamic grant scheduling mode based at least in part on the energy harvesting state having a charging rate that satisfies a threshold. In some aspects, the preferred scheduling mode is the configured grant scheduling mode based at least in part on the energy harvesting state having a charging rate that fails to satisfy a threshold.

In some aspects, transmitting the indication is based at least in part on a change in the energy harvesting state of the UE. In some aspects, the change in the energy harvesting state of the UE is a trigger condition for transmission of the indication. In some aspects, the preferred scheduling mode is based at least in part on whether the transmission is a periodic transmission.

In some aspects, the indication indicates whether to support PDCCH monitoring associated with HARQ retransmission for the configured grant scheduling mode.

In some aspects, the indication indicates one or more parameters for the configured grant or the dynamic grant. In some aspects, the one or more parameters include at least one of a buffer status, a grant size, a periodicity, one or more indexes associated with one or more configured grants, a logical channel group identifier associated with the indication, or a preferred number of configured grant occasions. In some aspects, the indication indicates the one or more parameters based at least in part on a change in the energy harvesting state of the UE. In some aspects, method 800 includes receiving signaling indicating a modified configured grant based at least in part on the indication. In some aspects, transmitting the indication is based at least in part on a timer that indicates a minimum length of time between transmissions of the indication. In some aspects, the indication is included in at least one of medium access control signaling, or radio resource control signaling.

At 840, the UE may receive a dynamic grant or an activation of a configured grant in accordance with the preferred scheduling mode. For example, the UE (e.g., using communication manager 140 and/or reception component 1002, depicted in FIG. 10) may receive a dynamic grant (e.g., a grant conveyed via DCI) or an activation (e.g., via RRC or DCI signaling) of a configured grant in accordance with the preferred scheduling mode, as described above in connection with, for example, FIGS. 5-7 and at 550, 640, and 745. For example, if the preferred scheduling mode is a dynamic grant scheduling mode, the UE may receive a dynamic grant. If the preferred scheduling mode is a configured grant scheduling mode, the UE may receive an activation of a configured grant.

At 850, the UE may perform a transmission in accordance with the dynamic grant or the configured grant. For example, the UE (e.g., using communication manager 140 and/or transmission component 1004, depicted in FIG. 10) may perform a transmission in accordance with the dynamic grant or the configured grant, as described above in connection with, for example, FIGS. 5-7 and at 560, 650, 725, and 750. In some aspects, performing the transmission in accordance with the configured grant further comprises transmitting data in a plurality of configured grant occasions of the configured grant.

In some aspects, method 800 includes skipping one or more configured grant occasions of the plurality of configured grant occasions based at least in part on the energy harvesting state of the UE. For example, the UE may skip the one or more configured grant occasions based at least in part on an energy level, a charging rate, a combination thereof, or another factor, as described elsewhere herein. In some aspects, method 800 includes receiving a release of the configured grant based at least in part on a number of the one or more configured grant occasions satisfying a threshold. For example, a network node may release the configured grant if a threshold number of skipped configured grant occasions is exceeded. In some aspects, method 800 includes refraining from monitoring a physical downlink control channel during skipping the one or more configured grant occasions.

Although FIG. 8 shows example blocks of method 800, in some aspects, method 800 may include additional blocks, fewer blocks, different blocks, or differently arranged blocks than those depicted in FIG. 8. Additionally, or alternatively, two or more of the blocks of method 800 may be performed in parallel.

FIG. 9 is a flowchart of an example method 900 of wireless communication. The method 900 may be performed by, for example, a network node (e.g., base station 110, CU 410, DU 430, RU 440, or a combination thereof).

At 910, the network node may optionally transmit a CG configuration of a UE. For example, the network node (e.g., using communication manager 150 and/or configuration component 1108) may transmit one or more CG configurations to the UE. In some aspects, the one or more CG configurations may be identified by one or more indexes (e.g., one index per CG configuration). As used herein, “transmission” can refer to transmission via an air interface, or transmission via a link such as a backhaul link, a midhaul link, or a fronthaul link.

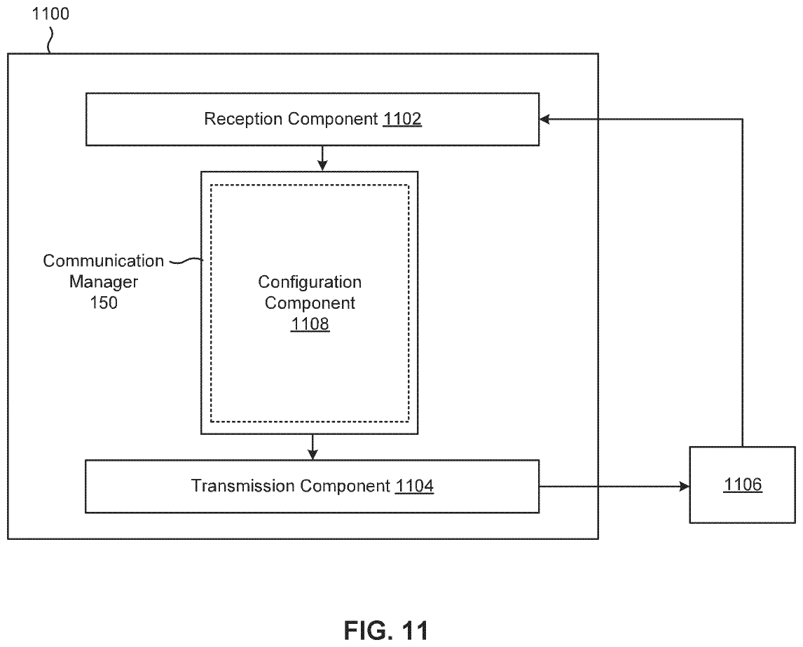

At 920, the network node may receive, based at least in part on an energy harvesting state of a UE, an indication of a preferred scheduling mode. For example, the network node (e.g., using communication manager 150 and/or reception component 1102, depicted in FIG. 11) may receive, based at least in part on an energy harvesting state of a UE, an indication of a preferred scheduling mode. The preferred scheduling mode may be selected (by the UE) from a dynamic grant scheduling mode and a configured grant scheduling mode, as described above in connection with, for example, FIGS. 5-7 at 540, 630, and 715. In some aspects, receiving the indication is based at least in part on a change in the energy harvesting state of the UE. In some aspects, the change in the energy harvesting state of the UE is a trigger condition for transmission of the indication. In some aspects, the preferred scheduling mode is based at least in part on whether the transmission is a periodic transmission. In some aspects, the indication indicates whether to support PDCCH monitoring associated with HARQ retransmission for the configured grant scheduling mode. In some aspects, the indication is based at least in part on a timer that indicates a minimum length of time between transmissions of the indication. In some aspects, the indication is included in at least one of medium access control signaling, or radio resource control signaling.

At 930, the network node may transmit a dynamic grant or an activation of a configured grant in accordance with the preferred scheduling mode. For example, the network node (e.g., using communication manager 150 and/or transmission component 1104, depicted in FIG. 11) may transmit a dynamic grant or an activation of a configured grant in accordance with the preferred scheduling mode, as described above in connection with, for example, FIGS. 5-7 and at 550, 640, and 745. In some aspects, the indication indicates one or more parameters for the configured grant or the dynamic grant. The configured grant or the dynamic grant may be based at least in part on the one or more parameters. In some aspects, the one or more parameters include at least one of a buffer status, a grant size, a periodicity, one or more indexes associated with one or more configured grants, a logical channel group identifier associated with the indication, or a preferred number of configured grant occasions. In some aspects, the indication indicates the one or more parameters based at least in part on a change in the energy harvesting state of the UE. In some aspects, method 900 includes transmitting signaling indicating a modified configured grant based at least in part on the indication. In some aspects, method 900 includes transmitting a release of the configured grant based at least in part on a number of skipped consecutive configured grant occasions satisfying a threshold.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of an energy harvesting component 1008 or an energy management component 1010, among other examples.

In some aspects, the apparatus 1000 may be configured to perform one or more operations described herein in connection with FIGS. 5-7. Additionally, or alternatively, the apparatus 1000 may be configured to perform one or more processes described herein, such as the method 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The transmission component 1004 may transmit, based at least in part on an energy harvesting state of the UE, an indication of a preferred scheduling mode selected from a dynamic grant scheduling mode and a configured grant scheduling mode. The reception component 1002 may receive a dynamic grant or an activation of a configured grant in accordance with the preferred scheduling mode. The transmission component 1004 may perform a transmission in accordance with the dynamic grant or the configured grant.

The energy harvesting component 1008 may perform energy harvesting, wherein the energy harvesting state is based at least in part on an energy level or a charging rate associated with the energy harvesting.

The reception component 1002 may receive signaling indicating a modified configured grant based at least in part on the indication.

The energy harvesting component 1008 may perform energy harvesting between a first configured grant occasion and a second configured grant occasion of the configured grant.

The energy management component 1010 may skip one or more configured grant occasions of the plurality of configured grant occasions based at least in part on the energy harvesting state of the UE.

The reception component 1002 may receive a release of the configured grant based at least in part on a number of the one or more configured grant occasions satisfying a threshold.

The reception component 1002 may refrain from monitoring a physical downlink control channel during skipping the one or more configured grant occasions.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include one or more of a configuration component 1108, among other examples.

In some aspects, the apparatus 1100 may be configured to perform one or more operations described herein in connection with FIGS. 5-7. Additionally, or alternatively, the apparatus 1100 may be configured to perform one or more processes described herein, such as method 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The reception component 1102 may receive, based at least in part on an energy harvesting state of a UE, an indication of a preferred scheduling mode selected from a dynamic grant scheduling mode and a configured grant scheduling mode. The transmission component 1104 may transmit a dynamic grant or an activation of a configured grant in accordance with the preferred scheduling mode.

The configuration component 1108 may transmit signaling indicating a modified configured grant based at least in part on the indication.

The configuration component 1108 may transmit a release of the configured grant based at least in part on a number of skipped consecutive configured grant occasions satisfying a threshold.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. For example, a first component may be implemented at a CU (e.g., CU 410), and a second component may be implemented at a DU (e.g., DU 430). Additionally, or alternatively, a third component may be implemented at an RU (e.g., RU 440). In some aspects, a set of (one or more) components shown in FIG. 11 may perform one or more functions described as being performed by another set of components shown in FIG. 11.

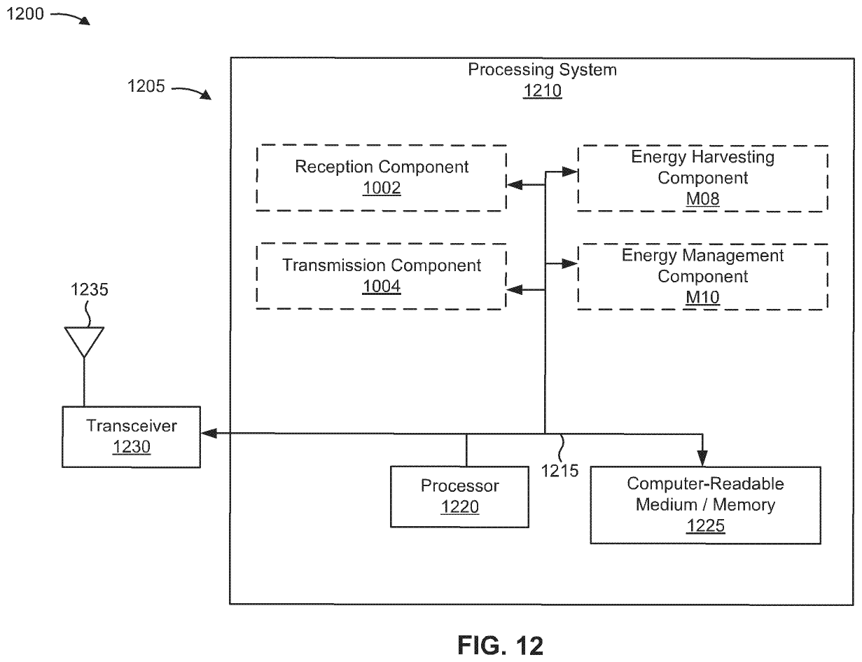

FIG. 12 is a diagram illustrating an example 1200 of a hardware implementation for an apparatus 1205 employing a processing system 1210. The apparatus 1205 may be a UE.

The processing system 1210 may be implemented with a bus architecture, represented generally by the bus 1215. The bus 1215 may include any number of interconnecting buses and bridges depending on the specific application of the processing system 1210 and the overall design constraints. The bus 1215 links together various circuits including one or more processors and/or hardware components, represented by the processor 1220, the illustrated components, and the computer-readable medium/memory 1225. The bus 1215 may also link various other circuits, such as timing sources, peripherals, voltage regulators, and/or power management circuits.

The processing system 1210 may be coupled to a transceiver 1230. The transceiver 1230 is coupled to one or more antennas 1235. The transceiver 1230 provides a means for communicating with various other apparatuses over a transmission medium. The transceiver 1230 receives a signal from the one or more antennas 1235, extracts information from the received signal, and provides the extracted information to the processing system 1210, specifically the reception component 1002. In addition, the transceiver 1230 receives information from the processing system 1210, specifically the transmission component 1004, and generates a signal to be applied to the one or more antennas 1235 based at least in part on the received information.

The processing system 1210 includes a processor 1220 coupled to a computer-readable medium/memory 1225. The processor 1220 is responsible for general processing, including the execution of software stored on the computer-readable medium/memory 1225. The software, when executed by the processor 1220, causes the processing system 1210 to perform the various functions described herein for any particular apparatus. The computer-readable medium/memory 1225 may also be used for storing data that is manipulated by the processor 1220 when executing software. The processing system further includes at least one of the illustrated components. The components may be software modules running in the processor 1220, resident/stored in the computer-readable medium/memory 1225, one or more hardware modules coupled to the processor 1220, or some combination thereof.

In some aspects, the processing system 1210 may be a component of the UE 120 and may include the memory 282 and/or at least one of the TX MIMO processor 266, the RX processor 258, and/or the controller/processor 280. In some aspects, the apparatus 1205 for wireless communication includes means for means for transmitting, based at least in part on an energy harvesting state of the UE, an indication of a preferred scheduling mode selected from a dynamic grant scheduling mode and a configured grant scheduling mode; means for receiving a dynamic grant or an activation of a configured grant in accordance with the preferred scheduling mode; and/or means for performing a transmission in accordance with the dynamic grant or the configured grant. The aforementioned means may be one or more of the aforementioned components of the apparatus 1000 and/or the processing system 1210 of the apparatus 1205 configured to perform the functions recited by the aforementioned means. As described elsewhere herein, the processing system 1210 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 12 is provided as an example. Other examples may differ from what is described in connection with FIG. 12.

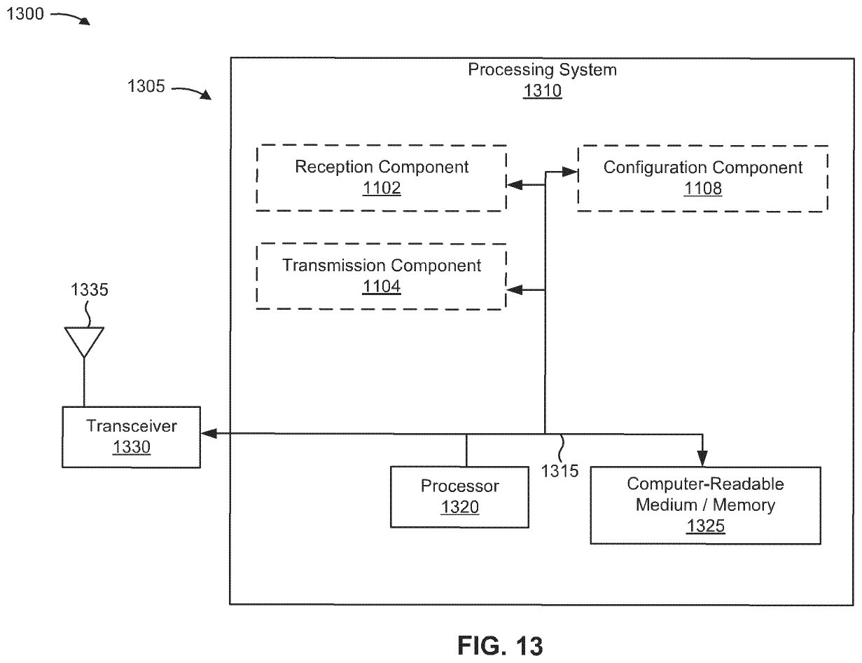

FIG. 13 is a diagram illustrating an example 1300 of a hardware implementation for an apparatus 1305 employing a processing system 1310. The apparatus 1305 may be a network node.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor 1320, the illustrated components, and the computer-readable medium/memory 1325. The bus 1315 may also link various other circuits, such as timing sources, peripherals, voltage regulators, and/or power management circuits.

In some examples, the processing system 1310 may be coupled to a transceiver 1330. The transceiver 1330 may be coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1102. In addition, the transceiver 1330 receives information from the processing system 1310, specifically the transmission component 1104, and generates a signal to be applied to the one or more antennas 1335 based at least in part on the received information. In some examples, the apparatus 1305 may include an interface for communication with one or more network nodes, such as via a backhaul, midhaul, or fronthaul link. In some aspects, the interface may include the transceiver 1330 and/or the one or more antennas 1335. In some other aspects, the apparatus 1305 may not include the transceiver 1330 and/or the one or more antennas 1335.

The processing system 1310 includes a processor 1320 coupled to a computer-readable medium/memory 1325. The processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer-readable medium/memory 1325, one or more hardware modules coupled to the processor 1320, or some combination thereof.

In some aspects, the processing system 1310 may be a component of the base station 110 and may include the memory 242 and/or at least one of the TX MIMO processor 230, the RX processor 238, and/or the controller/processor 240. In some aspects, the processing system 1310 may be a component of a CU (e.g., CU 410). In some aspects, the processing system 1310 may be a component of a DU (e.g., DU 430). In some aspects, the processing system 1310 may be a component of an RU (e.g., RU 440). In some aspects, the apparatus 1305 for wireless communication includes means for receiving, based at least in part on an energy harvesting state of a UE, an indication of a preferred scheduling mode selected from a dynamic grant scheduling mode and a configured grant scheduling mode; and/or means for transmitting a dynamic grant or an activation of a configured grant in accordance with the preferred scheduling mode. The aforementioned means may be one or more of the aforementioned components of the apparatus 1100 and/or the processing system 1310 of the apparatus 1305 configured to perform the functions recited by the aforementioned means. As described elsewhere herein, the processing system 1310 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 13 is provided as an example. Other examples may differ from what is described in connection with FIG. 13.

The following provides an overview of some Aspects of the present disclosure:

Aspect 1: A method of wireless communication performed by a user equipment (UE), comprising: transmitting, based at least in part on an energy harvesting state of the UE, an indication of a preferred scheduling mode selected from a dynamic grant scheduling mode and a configured grant scheduling mode; receiving a dynamic grant or an activation of a configured grant in accordance with the preferred scheduling mode; and performing a transmission in accordance with the dynamic grant or the configured grant.

Aspect 2: The method of Aspect 1, further comprising performing energy harvesting, wherein the energy harvesting state is based at least in part on an energy level or a charging rate associated with the energy harvesting.

Aspect 3: The method of any of Aspects 1-2, wherein the preferred scheduling mode is the dynamic grant scheduling mode based at least in part on the energy harvesting state having an energy level that satisfies a threshold.

Aspect 4: The method of any of Aspects 1-2, wherein the preferred scheduling mode is the configured grant scheduling mode based at least in part on the energy harvesting state having an energy level that fails to satisfy a threshold.

Aspect 5: The method of any of Aspects 1-4, wherein the preferred scheduling mode is the dynamic grant scheduling mode based at least in part on the energy harvesting state having a charging rate that satisfies a threshold.

Aspect 6: The method of any of Aspects 1-4, wherein the preferred scheduling mode is the configured grant scheduling mode based at least in part on the energy harvesting state having a charging rate that fails to satisfy a threshold.

Aspect 7: The method of any of Aspects 1-6, wherein transmitting the indication is based at least in part on a change in the energy harvesting state of the UE.

Aspect 8: The method of Aspect 7, wherein the change in the energy harvesting state of the UE is a trigger condition for transmission of the indication.

Aspect 9: The method of any of Aspects 1-8, wherein the preferred scheduling mode is based at least in part on whether the transmission is a periodic transmission.

Aspect 10: The method of any of Aspects 1-9, wherein the indication indicates whether to support physical downlink control channel (PDCCH) monitoring associated with hybrid automatic repeat request (HARQ) retransmission for the configured grant scheduling mode.

Aspect 11: The method of any of Aspects 1-10, wherein the indication indicates one or more parameters for the configured grant or the dynamic grant.

Aspect 12: The method of Aspect 11, wherein the one or more parameters include at least one of: a buffer status, a grant size, a periodicity, one or more indexes associated with one or more configured grants, a logical channel group identifier associated with the indication, or a preferred number of configured grant occasions.

Aspect 13: The method of Aspect 11, wherein the indication indicates the one or more parameters based at least in part on a change in the energy harvesting state of the UE.

Aspect 14: The method of Aspect 11, further comprising: receiving signaling indicating a modified configured grant based at least in part on the indication.

Aspect 15: The method of Aspect 11, wherein transmitting the indication is based at least in part on a timer that indicates a minimum length of time between transmissions of the indication.

Aspect 16: The method of any of Aspects 1-15, wherein the indication is included in at least one of: medium access control signaling, or radio resource control signaling.

Aspect 17: The method of any of Aspects 1-16, further comprising: performing energy harvesting between a first configured grant occasion and a second configured grant occasion of the configured grant.

Aspect 18: The method of Aspect 17, further comprising: monitoring, during the energy harvesting, for network signaling within a monitoring window.

Aspect 19: The method of any of Aspects 1-18, wherein performing the transmission in accordance with the configured grant further comprises: transmitting data in a plurality of configured grant occasions of the configured grant.

Aspect 20: The method of Aspect 19, further comprising: skipping one or more configured grant occasions of the plurality of configured grant occasions based at least in part on the energy harvesting state of the UE.

Aspect 21: The method of Aspect 20, further comprising: receiving a release of the configured grant based at least in part on a number of the one or more configured grant occasions satisfying a threshold.

Aspect 22: The method of Aspect 20, further comprising refraining from monitoring a physical downlink control channel during skipping the one or more configured grant occasions.

Aspect 23: A method of wireless communication performed by a network node, comprising: receiving, based at least in part on an energy harvesting state of a user equipment (UE), an indication of a preferred scheduling mode selected from a dynamic grant scheduling mode and a configured grant scheduling mode; and transmitting a dynamic grant or an activation of a configured grant in accordance with the preferred scheduling mode.

Aspect 24: The method of Aspect 23, wherein receiving the indication is based at least in part on a change in the energy harvesting state of the UE.

Aspect 25: The method of Aspect 24, wherein the change in the energy harvesting state of the UE is a trigger condition for transmission of the indication.

Aspect 26: The method of any of Aspects 23-25, wherein the preferred scheduling mode is based at least in part on whether the transmission is a periodic transmission.

Aspect 27: The method of any of Aspects 23-26, wherein the indication indicates whether to support physical downlink control channel (PDCCH) monitoring associated with hybrid automatic repeat request (HARQ) retransmission for the configured grant scheduling mode.

Aspect 28: The method of any of Aspects 23-27, wherein the indication indicates one or more parameters for the configured grant or the dynamic grant, wherein the configured grant or the dynamic grant is based at least in part on the one or more parameters.

Aspect 29: The method of Aspect 28, wherein the one or more parameters include at least one of: a buffer status, a grant size, a periodicity, one or more indexes associated with one or more configured grants, a logical channel group identifier associated with the indication, or a preferred number of configured grant occasions.

Aspect 30: The method of Aspect 28, wherein the indication indicates the one or more parameters based at least in part on a change in the energy harvesting state of the UE.

Aspect 31: The method of Aspect 28, further comprising: transmitting signaling indicating a modified configured grant based at least in part on the indication.

Aspect 32: The method of Aspect 28, wherein the indication is based at least in part on a timer that indicates a minimum length of time between transmissions of the indication.

Aspect 33: The method of any of Aspects 23-32, wherein the indication is included in at least one of: medium access control signaling, or radio resource control signaling.

Aspect 34: The method of any of Aspects 23-33, further comprising: transmitting a release of the configured grant based at least in part on a number of skipped consecutive configured grant occasions satisfying a threshold.

Aspect 35: An apparatus for wireless communication at a device, comprising a processor; memory coupled with the processor; and instructions stored in the memory and executable by the processor to cause the apparatus to perform the method of one or more of Aspects 1-34.

Aspect 36: A device for wireless communication, comprising a memory and one or more processors coupled to the memory, the one or more processors configured to perform the method of one or more of Aspects 1-34.

Aspect 37: An apparatus for wireless communication, comprising at least one means for performing the method of one or more of Aspects 1-34.

Aspect 38: A non-transitory computer-readable medium storing code for wireless communication, the code comprising instructions executable by a processor to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a +c, a +b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, based at least in part on an energy harvesting state of the UE, an indication of a preferred scheduling mode selected from a dynamic grant scheduling mode and a configured grant scheduling mode;
receive a dynamic grant or an activation of a configured grant in accordance with the preferred scheduling mode; and
perform a transmission in accordance with the dynamic grant or the configured grant.

2. The UE of claim 1, wherein the one or more processors are further configured to perform energy harvesting, wherein the energy harvesting state is based at least in part on an energy level or a charging rate associated with the energy harvesting.

3. The UE of claim 1, wherein the preferred scheduling mode is the dynamic grant scheduling mode based at least in part on the energy harvesting state having an energy level that satisfies a threshold.

4. The UE of claim 1, wherein the preferred scheduling mode is the configured grant scheduling mode based at least in part on the energy harvesting state having an energy level that fails to satisfy a threshold.

5. The UE of claim 1, wherein the preferred scheduling mode is the dynamic grant scheduling mode based at least in part on the energy harvesting state having a charging rate that satisfies a threshold.

6. The UE of claim 1, wherein the preferred scheduling mode is the configured grant scheduling mode based at least in part on the energy harvesting state having a charging rate that fails to satisfy a threshold.

7. The UE of claim 1, wherein transmitting the indication is based at least in part on a change in the energy harvesting state of the UE.

8. The UE of claim 7, wherein the change in the energy harvesting state of the UE is a trigger condition for transmission of the indication.

9. The UE of claim 1, wherein the preferred scheduling mode is based at least in part on whether the transmission is a periodic transmission.

10. The UE of claim 1, wherein the indication indicates whether to support physical downlink control channel (PDCCH) monitoring associated with hybrid automatic repeat request (HARQ) retransmission for the configured grant scheduling mode.

11. The UE of claim 1, wherein the indication indicates one or more parameters for the configured grant or the dynamic grant.

12. The UE of claim 11, wherein the one or more parameters include at least one of:
a buffer status,
a grant size,
a periodicity,
one or more indexes associated with one or more configured grants,
a logical channel group identifier associated with the indication, or
a preferred number of configured grant occasions.

13. The UE of claim 11, wherein the indication indicates the one or more parameters based at least in part on a change in the energy harvesting state of the UE.

14. The UE of claim 11, wherein the one or more processors are further configured to:
receive signaling indicating a modified configured grant based at least in part on the indication.

15. The UE of claim 11, wherein transmitting the indication is based at least in part on a timer that indicates a minimum length of time between transmissions of the indication.

16. The UE of claim 1, wherein the indication is included in at least one of:
medium access control signaling, or
radio resource control signaling.

17. The UE of claim 1, wherein the one or more processors are further configured to:
perform energy harvesting between a first configured grant occasion and a second configured grant occasion of the configured grant.

18. The UE of claim 1, wherein the one or more processors are further configured to:
monitoring, during the energy harvesting, for network signaling within a monitoring window.

19. The UE of claim 1, wherein the one or more processors, to perform the transmission in accordance with the configured grant, are configured to:
transmit data in a plurality of configured grant occasions of the configured grant.

20. The UE of claim 19, wherein the one or more processors are further configured to:
skip one or more configured grant occasions of the plurality of configured grant occasions based at least in part on the energy harvesting state of the UE.

21. The UE of claim 20, wherein the one or more processors are further configured to:
receive a release of the configured grant based at least in part on a number of the one or more configured grant occasions satisfying a threshold.

22. The UE of claim 20, wherein the one or more processors are further configured to refrain from monitoring a physical downlink control channel during skipping the one or more configured grant occasions.

23. A network node for wireless communication, comprising:
a memory; and
one or more processors, coupled to the memory, configured to:
receive, based at least in part on an energy harvesting state of a user equipment (UE), an indication of a preferred scheduling mode selected from a dynamic grant scheduling mode and a configured grant scheduling mode; and
transmit a dynamic grant or an activation of a configured grant in accordance with the preferred scheduling mode.

24. The network node of claim 23, wherein receiving the indication is based at least in part on a change in the energy harvesting state of the UE.

25. The network node of claim 23, wherein the indication indicates one or more parameters for the configured grant or the dynamic grant, wherein the configured grant or the dynamic grant is based at least in part on the one or more parameters, wherein the one or more parameters include at least one of:
a buffer status,
a grant size,
a periodicity,
one or more indexes associated with one or more configured grants,
a logical channel group identifier associated with the indication, or
a preferred number of configured grant occasions.

26. The network node of claim 23, wherein the one or more processors are further configured to:
transmit a release of the configured grant based at least in part on a number of skipped consecutive configured grant occasions satisfying a threshold.

27. A method of wireless communication performed by a user equipment (UE), comprising:
transmitting, based at least in part on an energy harvesting state of the UE, an indication of a preferred scheduling mode selected from a dynamic grant scheduling mode and a configured grant scheduling mode;
receiving a dynamic grant or an activation of a configured grant in accordance with the preferred scheduling mode; and
performing a transmission in accordance with the dynamic grant or the configured grant.

28. The method of claim 27, wherein the preferred scheduling mode is the configured grant scheduling mode based at least in part on the energy harvesting state having an energy level that fails to satisfy a threshold.

29. A method of wireless communication performed by a network node, comprising:
receiving, based at least in part on an energy harvesting state of a user equipment (UE), an indication of a preferred scheduling mode selected from a dynamic grant scheduling mode and a configured grant scheduling mode; and
transmitting a dynamic grant or an activation of a configured grant in accordance with the preferred scheduling mode.

30. The method of claim 29, wherein the indication indicates one or more parameters for the configured grant or the dynamic grant, wherein the configured grant or the dynamic grant is based at least in part on the one or more parameters.
